(19) United States
(12) Patent Application Publication
(10) Pub. No.: US 2005/0271799 A1
(43) Pub. Date: Dec. 8, 2005

(54) Method for producing magnetic recording medium

(75) Inventors: Kenichi Moriwaki, Kanagawa (JP); Kazuyuki Usuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/142,385

(22) Filed: Jun. 2, 2005

(30) Foreign Application Priority Data
Jun. 2, 2004 (JP) P. 2004-164395

(51) Int. Cl. B05D 5/12; H01F 41/00

(52) U.S. Cl. 427/127; 427/457

(57) ABSTRACT

A method for producing a magnetic recording medium comprising a flexible polymer support, a magnetic layer having a granular structure and a protective layer in this order, the method comprising: forming the magnetic layer on at least one side of the flexible polymer support; and forming the protective layer with use of at least one ion source while conveying the flexible polymer support having the magnetic layer on at least its one side along a roll having a maximum surface roughness is from 0.01 to 0.4 μm.

### FIELD OF THE INVENTION

The present invention relates to a production method of a magnetic recording medium.

### BACKGROUND OF THE INVENTION

With recent spread of Internets, the utilization mode of computer is changing, for example, a large volume of video information or sound information is processed by using a personal computer. To keep up with this trend, the memory capacity required of magnetic recording mediums such as hard disk is also increasing.

In a hard disk apparatus, a magnetic head slightly floats from the surface of a magnetic disk along with the rotation of the magnetic disk, and the magnetic recording is performed in a non-contact manner. Therefore, the magnetic disk is prevented from damage due to contact of the magnetic head with the magnetic disk. The floating height of the magnetic head is gradually decreased as the magnetic recording density increases and at present, a floating height of 10 to 20 nm is realized with use of a magnetic disk comprising a mirror-polished ultrasmooth glass substrate having formed thereon a magnetic recording layer and the like. Generally, a CoPtCr-based magnetic layer/a Cr undercoat layer are used in the magnetic recording medium and by heating the magnetic recording medium to a high temperature of 200 to 500° C., the direction of easy magnetization of the CoPtCr-based magnetic layer is controlled to the in-plane direction of the film due to the Cr undercoat layer. Furthermore, segregation of Cr in the CoPtCr-based magnetic layer is accelerated and thereby, the magnetic domain in the magnetic layer is separated. By virtue of such technological innovation (e.g., reduction in the floating height of head, improvement of the head structure, improvement of the recording film of disk), the areal recording density and recording capacity of hard disk drives are markedly increased over the past few years.

The increase in the amount of digital data which can be handled brings about a need of recording large-volume data such as video data on a replaceable medium and moving the data. When the hard disk is intended to use as a replaceable medium like a flexible disk or a rewritable optical disk, this bears a high risk of causing failure due to mechanical shock or dust entrainment during operation, because the substrate is made of a hard material and as described above, the distance between head and disk is extremely narrow. Therefore, the hard disk cannot be used.

Furthermore, when a high-temperature sputtering film-forming method is used in the production of the medium, this not only incurs bad productivity but also leads to increase in the cost at the mass production, and low-cost production cannot be realized.

On the contrary, the flexible disk uses a substrate comprising a flexible polymer film and this is a medium capable of contact recording and therefore, ensures excellent replaceability and low-cost production. But, in flexible disks commercially available at present, the high-density recording properties of the magnetic layer are bad as compared with hard disks having a magnetic film formed by sputtering, and the recording density achieved is only 1/10 or less of that of hard disks, because these flexible disks have a structure that the recording film is formed by coating a magnetic substance on a polymer film together with a polymer binder and an abrasive.

In order to solve these problems, a ferromagnetic metal thin film flexible disk having a recording layer formed by the same sputtering method as in hard disks has been proposed. However, when the same magnetic layer as in hard disks is intended to form on a polymer film, the polymer film is greatly damaged by heat and such a flexible disk can be hardly used in practice. To cope with this, it has been also proposed to use a highly heat-resistant polyimide or aromatic polyamide film as the polymer films, but these heat-resistant films are very expensive and disks using such a film are difficult of practical use. If the magnetic layer is formed in a state of the polymer film being cooled so as not to give thermal damage to the polymer film, the magnetic properties of the magnetic layer are insufficient and the recording density can be hardly enhanced.

On the other hand, it has been known that when a ferromagnetic metal thin-film magnetic layer comprising a ferromagnetic metal alloy and a nonmagnetic oxide is used in combination with an Ru-based undercoat layer, almost the same magnetic properties as those of the CoPtCr-based magnetic layer formed under a high-temperature condition of 200 to 500° C. can be obtained even if the film formation is performed at room temperature (see, JP-A-2001-291230 (the term “JP-A” as used herein means an “unexamined published Japanese patent application”) and JP-A-2003-99918). Such a ferromagnetic metal thin-film magnetic layer comprising a ferromagnetic metal alloy and a nonmagnetic oxide has a so-called granular structure proposed for hard disks, and those described in JP-A-5-73880 and JP-A-7-311929 can be used. However, in flexible disks using a metal thin-film magnetic layer on a polymer film, a sufficiently high running durability cannot be obtained at present due to sliding abrasion with the magnetic head at the contact recording and reproduction. In order to solve this problem, studies are being made on an RF plasma CVD system DLC (diamond-like carbon) protective layer which is film-formed in the state of the substrate being supplied along a can (see, for example, JP-A-3-113824 and JP-A-10-219459). In film-forming the protective layer by the RF plasma CVD system, the carbon ionized in plasma must be drawn by applying a bias voltage to the substrate side. However, an electrically conducting substance and an insulating substance are mixed in the magnetic layer having a granular structure and therefore, when a bias voltage is applied, the bias cannot be satisfactorily applied to the magnetic layer surface, as a result, a protective layer with high hardness can be hardly obtained.

When a DLC protective layer by the RF plasma CVD system is intended to form in a web-mode apparatus, a large amount of carbon film attaches to the reaction tube part in which a high-density plasma is produced, and in continuing the film formation for a long time, carbon flakes as contamination adhere to the substrate to cause adverse effects. Therefore, it is difficult to apply this technique to a long web. Furthermore, since the discharge part by the reaction tube has a circular shape, thickness unevenness is generated in the width direction of the web. As a countermeasure therefor, a mask may be provided between the reaction tube and the substrate, but this not only incurs reduction of productivity but also gives rise to a cause of generating new contamination, and its application to a web is difficult.

Also, a technique of film-forming a hard protective layer by an ion beam deposition method using an ion beam gun having a hot filament or a grid is being studied (see, for example, JP-A-2000-260020 and JP-A-2002-109718). However, film formation of the protective layer cannot be continued for a long time, because the hot filament has a short life or contamination is generated due to the grid between the ion source and the substrate. Furthermore, since the ion beam gun also has a circular shape, the above-described problem of unevenness in thickness cannot be overcome.

In addition, it has been known that in actually forming such a hard carbon protective layer on a web, particularly, in forming the protective layer on both surfaces of the web, when a film-forming roll with a rough surface is used to attain good slipperiness, the web slips on the film-forming roll due to a small contact area with the web to increase the medium defects and the surface roughness of the roll adversely affects the surface property of the medium.

In write-once read-many or rewritable optical disks represented by DVD-R/RW, the head and the disk are not close to each other as in magnetic disks. Therefore, their replaceability is excellent and these optical disks are widespread. However, considering the thickness of light pickup and the cost, a disk structure that both surfaces can work out to a recording surface as in magnetic disks, which is advantageous for realizing high capacity, can be hardly used in the optical disk. Furthermore, due to low areal recording density and low data transfer speed as compared with magnetic disks, the performance of optical disks is not yet satisfied in the light of use as a rewritable high-capacity recording medium.

### SUMMARY OF THE INVENTION

As described above, a high-capacity rewritable replaceable recording medium satisfying the performance, reliability and cost is not present, though the demand therefor is high.

The present invention has been made by taking account of those problems in conventional techniques and an object of the present invention is to provide an inexpensive high-capacity magnetic recording medium with high performance and high reliability by forming at least a magnetic layer having a granular structure and a protective layer on a flexible polymer support without generating contamination or defects.

The means for achieving the above-described object are as follow.

(1) A method for producing a magnetic recording medium by forming at least a magnetic layer having a granular structure and a protective layer in this order on at least one surface of a flexible polymer support, the method comprising a step of forming the magnetic layer on the flexible polymer support, and a step of film-forming a protective layer with use of at least one unit of ion source while conveying the flexible polymer support having formed thereon the magnetic layer along a film-forming roll having a surface property that the maximum surface roughness (Rz) is from 0.01 to 0.4 μm.

(2) The method for producing a magnetic recording medium as described in (1) above, wherein the magnetic layer is plasma-treated and then the protective layer is film-formed while conveying the flexible polymer support having formed thereon the magnetic layer along the film-forming roll.

(3) The method for producing a magnetic recording medium as described in (1) or (2) above, wherein a multilayer protective layer is formed with use of a plurality of ion sources while conveying the flexible polymer support having formed thereon the magnetic layer along the film-forming roll.

According to the present invention, a magnetic recording medium which is suitably used in a high-density magnetic recording apparatus and reduced in the interaction among ferromagnetic substances and ensures low noise and high reliability, can be produced at a low cost by process of film formation at room temperature.

### BRIEF DESCRIPTION OF THE DRAWINGS

FIG. 1 is a view for explaining the production method in one embodiment of the present invention.

FIG. 2 is a view for explaining the production method in another embodiment of the present invention.

FIG. 3 is an oblique perspective figure showing one of an embodiment in which the ion source is provided.

FIG. 4 is a cross-section view of FIG. 3 along the line X-X.

FIG. 5 is a overhead plan view of FIG. 3.

### DESCRIPTION OF NUMERICAL REFERENCES

11 Flexible polymer support having formed thereon a magnetic layer
12 Let-off roll
13, 14, 15, 18 Roll
161, 162 Film-forming roll
171, 172, 173, 174 Ion source
19 Take-up roll
21, 22 Plasma irradiation device

### DETAILED DESCRIPTION OF THE INVENTION

The magnetic recording medium of the present invention comprises at least a magnetic layer having a granular structure, so that even when the medium is produced by process of film formation at room temperature, high-density recording comparable to that in hard disks and high capacity can be realized and the interaction between ferromagnetic substances can be made small.

Furthermore, a protective layer such as hard carbon film is formed on the magnetic layer by ion beam deposition without generation of contamination or defects, so that a satisfactory running durability can be obtained at the contact recording/reproduction with a magnetic head and a highly reliable magnetic recording medium can be provided.

By virtue of formation of these magnetic layer and protective layer, the substrate need not be heated unlike conventional techniques and even when the substrate temperature is room temperature, a magnetic recording medium having good S/N properties can be obtained. Accordingly, the support is not thermally damaged even if it is a polymer film, and a flat magnetic tape or flexible disk having resistance to contact recording can also be provided.

The production method of the present invention can produce a magnetic recording medium in either a tape shape or a flexible disk shape. The flexible disk using a flexible polymer film substrate has a structure that a center hole is formed in the central part, and this disk is encased in a cartridge made of plastic or the like. The cartridge is generally equipped with an access window covered with a metallic shutter, and a magnetic head is introduced through the access window, whereby recording of signal on the flexible disk and reproduction are performed.

The flexible disk is described below, but the contents thereof can apply also to the tape.

The flexible disk comprises a magnetic layer and a protective layer on each of both surfaces of a disk-like support comprising a flexible polymer film, but is preferably constituted such that an undercoat layer for improving surface property and gas barrier property, a gas barrier layer having functions of adhesion gas barrier property, an underlying layer for controlling the crystal orientation of the magnetic layer, a magnetic layer, a protective layer for protecting the magnetic layer from corrosion and abrasion, and a lubricating layer for improving running durability and corrosion resistance are stacked in this order on the support.

The magnetic layer may be either an in-plane magnetic recording film in which the easy magnetization axis is oriented in the horizontal direction with respect to the substrate, or a perpendicular magnetic recording film in which the easy magnetization axis is oriented in the perpendicular direction with respect to the substrate. The direction of this easy magnetization axis can be controlled by the material and crystal structure of the underlying layer and the composition and film-forming conditions of the magnetic film.

The magnetic layer has a granular structure and is also called a granular magnetic layer. The granular magnetic layer comprises a ferromagnetic metal alloy and a nonmagnetic oxide. The granular structure is macro-scopically a structure that a ferromagnetic metal alloy and a nonmagnetic oxide are mixed, but microscopically a structure that a nonmagnetic oxide covers a ferromagnetic metal alloy fine particle. The size of the ferromagnetic metal alloy particle is approximately from 1 to 110 nm. By virtue of such a structure, a high coercive force can be achieved and since the dispersity of the magnetic particle size becomes uniform, a low-noise medium can be realized.

As for the ferromagnetic metal alloy, alloys with an element such as Co, Cr, Pt, Ni, Fe, B, Si, Ta, Nb and Ru can be used, but when the recording properties are taken account of, Co—Pt—Cr, Co—Pt—Cr—Ta, Co—Pt—Cr—B, Co—Ru—Cr and the like are particularly preferred.

As for the nonmagnetic oxide, oxides of Si, Zr, Ta, B, Ti, Al, Cr, Ba, Zn, Na, La, In, Pb and the like can be used, but when the recording properties are taken account of, SiOₓ is most preferred.

The mixing ratio (by mol) of a ferromagnetic metal alloy to a nonmagnetic oxide is preferably ferromagnetic metal alloy:nonmagnetic oxide=from 95:5 to 80:20, more preferably from 90:10 to 85:15. By adjusting the mixing ratio in this way, satisfactory separation among magnetic particles can be attained, and coercive force as well as magnetization amount and in turn signal output are ensured.

The thickness of the granular magnetic layer is preferably from 5 to 60 nm, more preferably from 5 to 30 nm. With the thickness in this range, the output can be ensured by decreasing noise as well as effect of thermal fluctuation and at the same time, resistance to the stress imposed at the head-medium contact and in turn, running durability can be ensured.

The granular magnetic layer can be formed by using a vacuum film-forming method such as vacuum deposition or sputtering. Particularly, a sputtering method is preferred in the present invention, because an ultrathin film with good quality can be easily formed. Examples of the sputtering method which can be used include known DC sputtering method and RF sputtering method. The sputtering is preferably performed by using a web sputtering apparatus of continuously film-forming the magnetic layer on a continuous film, but a single-wafer sputtering apparatus or an in-line sputtering apparatus as employed in the case of using an Al substrate or a glass substrate can also be used.

As for the sputtering gas at the sputtering, a generally employed argon gas can be used, but other rare gases may also be used. Furthermore, a trace amount of oxygen gas may be introduced for the purpose of adjusting the oxygen content in a nonmagnetic oxide or for surface oxidation.

For forming the granular magnetic layer by sputtering, a co-sputtering method using two kinds of targets, that is, a ferromagnetic metal alloy target and a nonmagnetic oxide target may be employed, but in order to improve the magnetic particle size dispersity and thereby form a homogeneous film, an alloy target comprising a ferro-magnetic metal alloy and a nonmagnetic oxide is preferably used. This alloy target can be produced by a hot-press method.

The Ar pressure at the time of forming the granular magnetic layer by sputtering is preferably 5 to 10 mTorr (from 0.665 to 13.3 Pa), more preferably from 10 to 50 mTorr (from 1.33 to 6.55 Pa). By setting the Ar pressure at the film formation to this range, the crystallinity of the magnetic layer and the separation among magnetic particles are ensured, satisfactory magnetic properties are obtained, and a highly reliable magnetic recording medium with low noise and sufficient film strength can be provided.

The electric powder charged at the time of forming the granular magnetic layer by sputtering is preferably from 1 to 100 W/cm², more preferably from 2 to 50 W/cm², With an electric powder in this range, crystallinity and film adhesion can be ensured and at the same time, deformation of support or generation of cracks in the sputtered film can be prevented.

The protective layer preferably comprises a hard carbon film and this layer is provided to prevent corrosion of metal materials contained in the magnetic layer, protect the magnetic layer from abrasion due to pseudo-contact or contact-sliding between the magnetic head and the magnetic disk and thereby improve the running durability and corrosion resistance. As for the protective layer satisfying these purposes, a hard film having a hardness equal to or greater than that of the construction material of the magnetic head, being less baked during sliding and stably maintaining the effect is preferred because of its excellent sliding durability, and a hard film reduced in the contamination or pinholes in addition to those properties is more preferred in view of excellent corrosion resistance and running durability. Examples of the hard carbon film used for such a protective layer include those called DLC (diamond-like carbon). The protective layer which is a hard protective layer comprising a hard carbon film is described below.

As for the method of evaluating the film property of the hard carbon film, a Raman spectroscopy is known. When the Raman spectrum of hard carbon film is examined, a broad peak is observed at a Raman shift of 1,000 to 1,800 cm⁻¹.

The hard carbon film for use in the present invention is preferably controlled such that in the Raman spectrum of the hard carbon film by the Raman spectroscopy, the ratio (ID/IG) of the intensity (IG) at the G peak having a peak in the range from 1,500 to 1,600 cm⁻¹ to the intensity (ID) at the D peak having a peak in the range from 1,350 to 1,430 cm⁻¹ is from 0.4 to 1.4, more preferably from 0.5 to 1.0.

The G peak comprises a main peak, and the D peak comprises a shoulder. The G peak and the D peak both are a peak attributable to the sp2 structure, but the peak intensity (ID/IG) is known to reflect the ratio of the sp3 structure.

The organic property (polymer component; a hydrogen-containing carbon component which is not hard) of the film can be evaluated, for example, by the ratio B/A of the G peak intensity B including background to the G peak intensity A not including background. In the present invention, the ratio B/A is preferably from 1.0 to 2.0, more preferably from 1.0 to 1.5.

In the magnetic recording/reproduction, a smaller distance between the magnetic head and the magnetic layer is advantageous to the high recording density. Therefore, the thickness of the protective layer is preferably from 2 to 10 nm, more preferably from 2 to 8 nm.

The method for forming such a hard carbon film includes an RF plasma CVD system and an ion beam deposition system, but an ion beam deposition system is preferred in view of film property, contamination, deformation of substrate, film thickness distribution and the like.

In the state of a hydrocarbon-based gas flowing, appropriate magnetic field and electric field are applied to the ion source used for the ion beam deposition, whereby a high-density plasma is formed. When a strong positive potential is applied to the ion source, the ionized carbon is pushed out and therefore, a dense carbon film is formed. That is, application of a bias voltage to the support or a grid giving rise to contamination is not necessary and therefore, a hard protective layer with less contamination can be film-formed even on a support where an electrically conducting substance and an insulating substance are mixed as in the granular magnetic layer. Furthermore, since parts having a short life, such as hot filament, are not used, a hard protective layer can be stably formed over a long period of time.

Examples of the gas which can be used at the time of forming the hard protective layer by ion beam deposition include a hydrocarbon-based gas, a rare gas such as Ar, and nitrogen. The chamber pressure at the film formation is preferably from 10 mTorr or less (1.33 Pa or less), more preferably 5 mTorr or less (0.655 Pa or less). When the chamber pressure is 10 mTorr or less (1.33 Pa or less), the carbon ion ionized in the high-density plasma is unlikely to collide against other ion and therefore, the energy of carbon ion is high, as a result, a denser and harder film is formed upon arrival at the substrate.

The potential applied to the anode in the ion source is preferably from 100 to 3,000 V, more preferably from 500 to 2,000, and the voltage applied to the cathode is preferably from 0 to −1,000 V, more preferably from 0 to −500 V. The magnetic field applied to the ion source surface is preferably from 0.03 T (300 G) to 1 T (10,000 G), more preferably from 0.05 T (500 G) to 0.5 T (5,000 G). When the potential and the magnetic filed are set in this way, the plasma density can be ensured, the ionization can be accelerated, the energy for pushing out the ionized carbon can be ensured, a sufficiently dense hard carbon film can be formed with less effect of the ionized carbon on the support, the deformation of support or generation of cracks in the film can be prevented, and the generation of arc between anode and cathode can be prevented.

In the present invention, an ion source is used. The ion source as used in the present invention means an ion source capable of irradiating ion beams at a uniform density in the width direction of the flexible polymer support, specifically, an ion source in which the electric discharge part has a length larger than the width of the flexible polymer support. The electric discharge part is not particularly limited in its shape as long as it has a length larger than the width of the flexible polymer support, but the electric discharge part preferably has a shape being capable of irradiating ion beams at a uniform density toward a region having a length larger than the width of the flexible polymer support, and preferable examples of the shape are rectangle, elliptic, track form, and the like. The distance between the ion source and the support at the film formation of the hard protective layer is preferably from 30 to 500 mm. By using such an ion source, a uniform hard carbon film can be formed in the width direction of the support. Therefore, a mask or the like for the correction of the film thickness distribution is not necessary and contamination can be prevented from occurring. Such an ion source is commercially available and examples thereof include LIS (trade name, produced by Advanced Energy), CD Ion Beam Source (trade name, produced by Diamonex), NANOCOAT (trade name, produced by Nanotec Corp.), Mark (trade name, produced by Common Wealth Scientific) and EH (trade name, produced by KRI).

The larger a length of the electric discharge part of the ion source is in comparison with the width of the flexible polymer-support, the less unevenness in thickness the hard carbon film provided on the flexible polymer support has. However, on the other hand, the larger a length of the electric discharge part of the ion source is in comparison with the width of the flexible polymer support, the more amount of unnecessary film adhesion portions other than the flexible polymer support such as film-forming roll and members around the film-forming part may have, and the number of defects may become larger. In order to avoid such defects, a means for preventing the film adhesion to the portions other than the flexible polymer support is preferably provided, and preferable examples of such means include an anti-adhesion plate (mask).

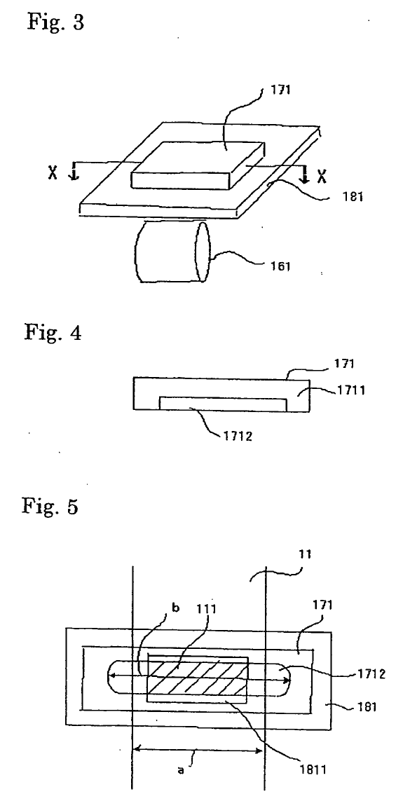

Embodiments of the setting of the ion source and the anti-adhesion plate are explained at below in view of FIGS. 3 to 5 (the present invention (for example, forms of the ion source and the anti-adhesion plate) is not limited to the embodiments shown in FIGS. 3 to 5 and explained below.).

As shown in FIG. 3, the ion source 171 and the film forming roll 161 are provided so that the anti-adhesion plate 181 is provided therebetween. And, as shown in FIG. 4, the ion source 171 includes a case 1711 and the electric discharge part 1712. A form of the electric discharge part 1712 is, for example, a track form as shown in FIG. 5, and the length b of the electric discharge part in the longitudinal direction is larger than the width a of the flexible polymer support (web) 11 to which the magnetic layer is provided and wherein the support is conveyed with the film-forming roll 161.

As shown in FIG. 5, the anti-adhesion plate 181 is provided so that it is over the both ends of the electric discharge part 1712 by which it is prevented that electric discharge is made to a region outside the web and unnecessary film adhesion is made toward portions other than the flexible polymer support such as film-forming roll 161. In addition, as shown in FIG. 5, the anti-adhesion plate 181 has a hole 1811 and electric discharge from the electric discharge part 1712 is passed through the hole 1811 and reached to a electric discharged area 111 (shaded area in FIG. 5) of the web so that the protective layer is provided at the area.

The anti-adhesion plate 181 is preferably surface-treated for improving film adhesion in its surface so that occurrence of defects with regard to the protective layer due to a peeling of film is prevented.

In the electric discharge with the use of the ion source 171 or in other steps, it may be not preferable that the anti-adhesion plate 181 is heated from the view point of the peeling of film. The length b of the electric discharge part 1712 and the width a of the web preferably meet the relationship, 1≦b/a<3, more preferably 1≦b/a<2, and still more preferably 1≦b/a<1.5.

In the present invention, the protective layer is film-formed while conveying the flexible polymer support having formed thereon the magnetic layer along a film-forming roll having a surface property that the maximum surface roughness (Rz) is from 0.01 to 0.4 μm.

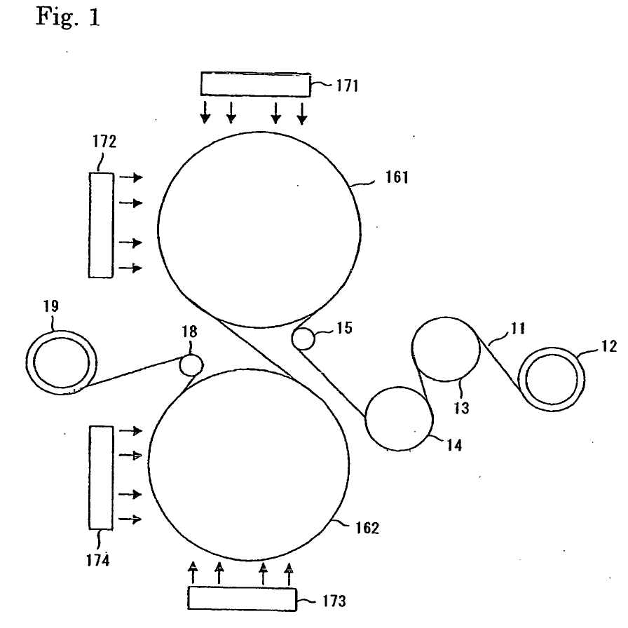

FIG. 1 is a view for explaining the production method according to the first embodiment of the present invention. In FIG. 1, a flexible polymer support 11 having formed thereon a magnetic layer is conveyed to a film-forming roll 161 from a let-off roll 12 through rolls 13, 14 and 15. The flexible polymer support 11 is conveyed along the film-forming roll 161 and irradiated with carbon ion flying from an ion source 171 provided to oppose the film-forming roll 161, whereby a hard protective layer is film-formed on the magnetic layer.

In the present invention, it is also possible to form a multi-layer protective layer on both surfaces of a flexible polymer support 11 having formed on both surfaces thereof a magnetic layer, as shown in FIG. 1, by using a plurality of ion sources 171, 172, 173 and 174 while conveying the flexible polymer support along a plurality of film-forming rolls 161 and 162. In the case of using a plurality of ion sources, the gas species supplied to each ion source and the mixing ratio thereof may be varied, whereby two or more hard protective layers differing in the property may be stacked on both surfaces in the process of once passing a film-forming roll. For example, when a hard carbon protective layer for improving the hardness and corrosion resistance is provided on the magnetic layer side and one or more nitrogen-added hard carbon protective layers for improving sliding properties are provided on the surface side, both corrosion resistance and durability can be established in a high level. In this case, each ion source is preferably provided so that each ion source can be prevented from adversely affecting the ion beam irradiated from another ion source. After the film formation of the hard protective layer, the polymer film is taken up on a take-up roll 19 through a roll 18. In the present invention, the numbers of film-forming rolls, ion sources and rolls are not limited to those shown in FIG. 1 and can be of course appropriately changed according to the purpose. The ion source is preferably provided to irradiate the ion beam from the direction perpendicular to the tangent line of the film-forming roll at the position along which the support is conveyed.

The film-forming roll for use in the present invention has, as described above, a maximum surface roughness (Rz) of 0.01 to 0.4 μm, preferably from 0.01 to 0.2 μm, more preferably from 0.01 to 0.1 μm. The maximum surface roughness (Rz) as used in the present invention means a value determined according to JIS B 0601-2001. In the present invention, since Rz is specified in this way, the film-forming roll has a very smooth surface and no adverse effect is caused by the roll surface roughness. Furthermore, the adhesive property to the support is enhanced, so that the conveyance slippage at the time of conveying the support and in turn, generation of defects on the medium can be prevented. The maximum surface roughness (Rz) can be adjusted by the surface finishing of the film-forming roll. Examples of the method therefore include a method of subjecting a metal roll surface to hard chromium plating and then to mirror-polishing finish.

For the purpose of allowing for tight contact of the support to prevent the conveyance slippage and causing the support to nearly oppose the ion source, the film-forming roll is preferably large to a certain extent, and the roll diameter is preferably 250 mm or more, more preferably 400 mm or more.

The conveyance speed of the support is preferably from 1 cm/min to 10 m/min, more preferably from 10 cm/min to 8 m/min. If the conveyance speed is less than 1 cm/min, the productivity is bad, whereas if it exceeds 10 m/min, the conveyance slippage of the support may have a non-negligible effect.

Before forming the protective layer on the support, the magnetic layer surface is preferably made to be physically or chemically active by a plasma treatment so as to enhance the adhesive property between the magnetic layer and the protective layer. The gas used for the plasma treatment is preferably an Ar gas, but other gases may also be used. In performing the plasma treatment, the electric power charged is preferably from 10 to 1,000 W, more preferably from 100 to 500 W. The treating time is preferably from 1 second to 2 minutes, but considering the film deformation or productivity, the treating time is more preferably from 1 to 30 seconds.

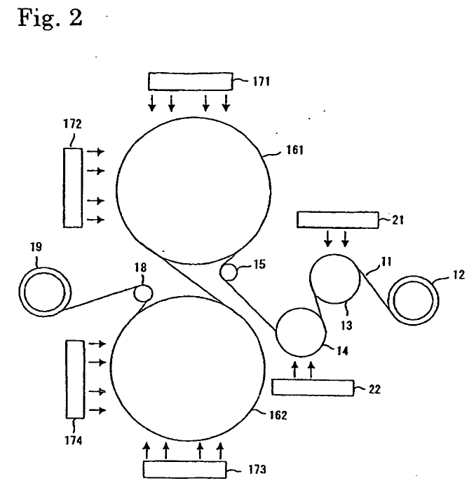

FIG. 2 is a view for explaining the production method in another embodiment of the present invention. As described above, the flexible polymer support 11 having formed thereon the magnetic layer is conveyed to the film-forming roll 161 from the let-off roll 12 through the rolls 13, 14 and 15 and the plasma treatment can be performed, for example, by providing one or both of plasma irradiation devices 21 and 22 above the rolls 13 and 14. The plasma treatment is preferably performed in this way between the let-off roll 12 and the film-forming roll 161 but may also be performed on the film-forming roll 161.

The rolls except for the film-forming roll may be appropriately surface-treated so as to convey the support without causing folds or scratches. For example, the metal roll surface is preferably finished through hard chrome plating and then mirror polishing finish to have a surface roughness Rz of 0.8 μm or less, more preferably 0.4 μm or less. By finishing the surface to a surface roughness of 0.8 μm or less, even in the case of contact-conveying a smooth support, a magnetic recording medium having surface smoothness can be produced without causing transfer of the roll surface roughness.

The underlying layer is preferably provided for the purpose of controlling the crystal orientation. As for the underlying layer, Ru, an Ru-based alloy, Cr, a Cr-based alloy, Ti, a Ti-based alloy or the like may be used, but in order to obtain satisfactory crystallinity by the film formation at room temperature, Ru or an Ru-based alloy is preferably used. By using such an underlying layer, the orientation of the magnetic layer can be improved and therefore, the recording properties are enhanced.

The thickness of the underlying layer is preferably from 5 to 100 nm, more preferably from 5 to 50 nm. If the thickness is larger than this range, the productivity decreases and the noise increases due to enlargement of crystal grains. Furthermore, since the resistance to stress imposed at the head-medium contact is low, reduction in the running durability is caused. On the other hand, if the thickness is less than the above-described range, enhancement of magnetic properties by the effect of the underlying layer cannot be obtained.

The underlying layer can be film-formed by using a vacuum film-forming method such as vacuum deposition or sputtering. Particularly, a sputtering method is preferred in the present invention, because an ultrathin film with good quality can be easily formed. Examples of the sputtering method which can be used include known DC sputtering method and RF sputtering method. In the case of a floppy disk where the support is a flexible polymer film, the sputtering is preferably performed by using a web sputtering apparatus of continuously film-forming the underlying layer on a continuous film, but a single-wafer sputtering apparatus or an in-line sputtering apparatus as employed in the case of using an Al substrate or a glass substrate can also be used.

As for the sputtering gas at the sputtering of underlying layer, a generally employed argon gas can be used, but other rare gases may also be used. Furthermore, a trace amount of oxygen gas may be introduced for the purpose of controlling the lattice constant of the underlying layer.

A seed layer may be provided right beneath the underlying layer for the purpose of, for example, enhancing crystal orientation of the underlying layer or imparting electrical conductivity.

As for the sheet layer, a Ti-based alloy, a W-based alloy, a V-based alloy are preferably used, but other alloys may be used.

The thickness of the seed layer is preferably from 1 to 30 nm. If the thickness is larger than this range, the productivity decreases and the noise increases due to enlargement of crystal grains, whereas if the thickness is less than the above-described range, the effect by the seed layer cannot be obtained.

The seed layer can be formed by using a vacuum film-forming method such as vacuum deposition and sputtering. Particularly, an ultrathin film with good quality can be easily formed by the sputtering method.

For the purpose of enhancing the adhesion and gas barrier property, a gas barrier layer is preferably provided between the substrate and the underlying layer.

As for the gas barrier layer, those comprising a nonmetallic simple element, a mixture thereof or a compound of Ti and a nonmetallic element may be used. These materials have resistance also to the stress at the head-medium contact.

The thickness of the gas barrier layer is preferably from 5 to 100 nm, more preferably from 5 to 50 nm. If the thickness is larger than this range, the productivity decreases and the noise increases due to enlargement of crystal grains, whereas if the thickness is smaller than the above-described range, the effect by the gas barrier layer cannot be obtained.

The gas barrier layer can be formed by using a vacuum film-forming method such as vacuum deposition and sputtering. Particularly, an ultrathin film with good quality can be easily formed by the sputtering method.

The support comprises a resin film having flexibility (flexible polymer support) so as to avoid impact when a magnetic head and a magnetic disk are brought into contact. Examples of such a resin film include a resin film comprising aromatic polyimide, aromatic polyamide, aromatic polyamideimide, polyether ketone, polyether sulfone, polyether imide, polysulfone, polyphenylene sulfide, polyethylene naphthalate, polyethylene terephthalate, polycarbonate, triacetate cellulose or fluororesin. In the present invention, good recording properties can be obtained without heating the substrate and therefore, polyethylene terephthalate and polyethylene naphthalate are particularly preferred in view of cost and surface property.

Also, a support obtained by laminating a plurality of resin films may be used. By using a laminated film, warp or undulation attributable to the support itself can be reduced and the scratch resistance of the magnetic recording layer can be remarkably improved.

Examples of the method for lamination include roll lamination by a heat roller, lamination by hot pressing with a flat plate, dry lamination of coating an adhesive on the adhesion surface and laminating the films, and lamination using an adhesive sheet previously shaped in a sheet form. The kind of the adhesive is not particularly limited, and a general adhesive such as hot melt adhesive, thermosetting adhesive, UV-curable adhesive, EB-curable adhesive, pressure-sensitive adhesive sheet and anaerobic adhesive can be used.

In the case that the magnetic recording medium is a flexible disk, the thickness of the support is preferably from 10 to 200 μm, more preferably from 20 to 150 μm, still more preferably from 30 to 100 μm. If the thickness of the support is less than 10 μm, stability at high-speed rotation decreases and plane runout increases, whereas if the thickness of the support is larger than 200 μm, rigidity at rotation increases and impact at the contact can be hardly avoided, as a result, jumping of a magnetic head is incurred.

In the case that the magnetic recording medium is a magnetic tape, the thickness of a support is preferably from 1 to 20 μm, more preferably from 3 to 12 μm. When the thickness of a support is less than 3 μm, the strength is insufficient, so that cutting or folding of edges are liable to occur. While when the thickness is more than 20 μm, the length of a magnetic tape that can be wound per one roll of tape becomes short, so that the volume recording density lowers. Further, since the rigidity during rotation becomes high, the touch to a magnetic head, i.e., following-up, deteriorates.

As for the nerve of the support, which is represented by the following formula, the value when b=10 mm is preferably from 0.5 to 2.0 kgf/mm² (from 4.9 to 19.6 MPa), more preferably from 0.7 to 1.5 kgf/mm² (from 6.86 to 14.7 MPa).
Nerve of support Ebd³/12
wherein E represents Young's modulus, b represents film width, and d represents film thickness.

The surface of the support is preferably as smooth as possible for performing recording by a magnetic head. The unevenness on the support surface conspicuously impairs the signal-recording/reproducing properties. More specifically, in the case of using an undercoat layer described later, the surface roughness in terms of the average center line roughness Ra measured by an optical surface roughness meter is 5 nm or less, preferably 2 nm or less, and the protrusion height measured by a stylus-type roughness meter is 1 μm or less, preferably 0.1 μm or less. In the case of not using an undercoat film, the surface roughness in terms of the average center line roughness Ra measured by an optical surface roughness meter is 3 nm or less, preferably 1 nm or less, and the protrusion height measured by a tracer roughness meter is 0.1 μm or less, preferably 0.06 μm or less.

For the purpose of improving planarity and gas barrier property, an undercoat layer is provided on the support surface. The undercoat layer preferably has excellent heat resistance because the magnetic layer is formed by sputtering or the like. Examples of the material which can be used for the undercoat layer include polyimide resin, polyamideimide resin, silicone resin and fluororesin. In particular, thermosetting polyimide resin and thermo-setting silicone resin are preferred because these material have a high smoothing effect. The thickness of the undercoat layer is preferably from 0.1 to 3.0 μm. In the case of laminating other resin films on the support, the undercoat layer may be formed before lamination or may be formed after lamination.

As for the thermosetting polyimide resin, a polyimide resin obtained by thermopolymerizing an imide monomer having two or more terminal unsaturated groups within the molecule, such as bisallylnadiimide “BANI” produced by Maruzen Petrochemical Co., Ltd., is preferably used. This imide monomer can be thermopolymerized at a relatively low temperature after coating it in the state of monomer on the support surface and therefore, the raw material monomer can be directly coated on the support and cured. Furthermore, the imide monomer can be used by dissolving it in a general-purpose solvent and this monomer ensures not only excellent productivity and workability but also small molecular weight and low solution viscosity, so that good filling of irregularities at the coating and in turn, high smoothing effect can be obtained.

As for the thermosetting silicone resin, a silicone resin obtained by a sol-gel method through polymerization starting from a silicon compound having introduced therein an organic group is preferably used. This silicone resin has a structure in which a part of the silicon dioxide bond is replaced by an organic group, and since this resin has heat resistance by far higher than that of silicon rubber and also has more excellent flexibility than that of silicon dioxide film, cracking or separation hardly occurs even when the resin film is formed on the support comprising a flexible polymer. Furthermore, the raw material monomer can be cured by directly coating it on the support, so that a general-purpose solvent can be used and good filling of irregularities and in turn, high smoothing effect can be obtained. Moreover, the condensation polymerization reaction proceeds from a relatively low temperature by the addition of a catalyst such as acid or chelating agent and therefore, curing can be attained in a short time and the resin film can be formed by using a general-purpose coating apparatus. In addition, the thermosetting silicone resin has excellent gas barrier property and gives a high gas barrier effect of blocking gases emitted from the support at the formation of the magnetic layer, which inhibit the crystallinity or orientation of the magnetic layer or underlying layer, and therefore, this resin is particularly preferred.

For the purpose of reducing the true contact area of a magnetic head and a magnetic disk and improving sliding property, fine protrusions (texture) are preferably provided on the surface of the undercoat layer. By providing fine protrusions, handleability of the support can be also enhanced. The fine protrusions may be formed, for example, by a method of coating spherical silica particles or a method of coating an emulsion and thereby forming fine protrusions of an organic material, but in order to ensure the heat resistance of the undercoat layer, the fine protrusions are preferably formed by coating spherical silica particles.

The height of fine protrusion is preferably from 5 to 60 nm, more preferably from 10 nm to 30 mm. If the height of fine protrusion is too large, the signal-recording/reproducing properties are deteriorated due to spacing loss between the recording/reproducing head and the medium, whereas if the height of fine protrusion is too small, the effect of improving the sliding property decreases. The density of fine protrusions is preferably from 0.1 to 100 protrusions/μm², more preferably from 1 to 10 protrusions/μm². If the density of fine protrusions is too small, the effect of improving the sliding property decreases, whereas if it is too large, high protrusions increase due to increase of aggregated particles, and the recording/reproducing properties are deteriorated.

Also, the fine protrusions may be fixed on the support surface by using a binder. The binder is preferably a resin having sufficiently high heat resistance. As for the resin having heat resistance, a solvent-soluble polyimide resin, a thermosetting polyimide resin and a thermosetting silicone resin are preferably used.

A lubricating layer is provided on the protective layer so as to improve the running durability and corrosion resistance. In the lubricating layer, a lubricant such as known hydrocarbon-based lubricant, fluorine-based lubricant and extreme-pressure additive is used.

Examples of the hydrocarbon-based lubricant include carboxylic acids such as stearic acid and oleic acid, esters such as butyl stearate, sulfonic acids such as octadecylsulfonic acid, phosphoric acid esters such as monooctadecyl phosphate, alcohols such as stearyl alcohol and oleyl alcohol, carboxylic acid amides such as stearic acid amide, and amines such as stearylamine.

Examples of the fluorine-based lubricant include lubricants obtained by replacing a part or all of alkyl groups in the above-described hydrocarbon-based lubricants with a fluoroalkyl group or a perfluoropolyether group. Examples of the perfluoropolyether group include a perfluoromethylene oxide polymer, a perfluoroethylene oxide polymer, a perfluoro-n-propylene oxide polymer (CF₂CF₂CF₂O)ₙ, a perfluoroisopropylene oxide polymer (CF(CF₃)CF₂O)ₙ, and a copolymer thereof. Specific examples thereof include a perfluoromethylene-perfluoroethylene copolymer having a hydroxyl group at the molecular weight terminal (e.g., “FOMBLIN Z DOL”, trade name, produced by Audimont Co.).

Examples of the extreme-pressure additive include phosphoric acid esters such as trilauryl phosphate, phosphorous acid esters such as trilauryl phosphite, thiophosphorous acid esters such as trilauryl trithiophosphite, thiophosphoric acid esters, and sulfur-based extreme-pressure additives such as dibenzyl disulfide.

The above-described lubricant can be used alone or a plurality of the lubricants can be used in combination. A solution obtained by dissolving the lubricant in an organic solvent may be coated on the protective layer surface by spin coating, wire bar coating, gravure coating or dip coating, or may be deposited on the protective layer surface by vacuum deposition. The amount of the lubricant coated is preferably from 1 to 30 mg/m², more preferably from 2 to 20 mg/m².

In order to more enhance the corrosion resistance, a rust inhibitor is preferably used in combination. Examples of the rust inhibitor include nitrogen-containing heterocyclic rings such as benzotriazole, benzimidazole, purine and pyrimidine, derivatives obtained by introducing an alkyl side chain or the like into the mother nucleus of these nitrogen-containing heterocyclic rings, nitrogen- and sulfur-containing heterocyclic rings such as benzothiazole, 2-mercaptobenzothiazole, tetraazaindene ring compound and thiouracyl compound, and derivatives of these nitrogen- and sulfur-containing heterocyclic rings. The rust inhibitor may be mixed with the lubricant and then coated on the protective layer. Alternatively, the rust inhibitor may be coated on the protective layer before coating the lubricant, and then the lubricant may be coated thereon. The amount of the rust inhibitor coated is preferably from 0.1 to 10 mg/m², more preferably from 0.5 to 5 mg/m².

### EXAMPLES

The present invention is described in greater detail below by referring to Examples and Comparative Examples, but the present invention should not be construed as being limited to these Examples.

### Example 1

An undercoat solution comprising 3-glycidoxypropyl-trimethoxysilane, phenyltriethoxysilane, hydrochloric acid, aluminum acetylacetonate and ethanol was coated on a polyethylene naphthalate film having a thickness of 63 μm and a surface roughness (Ra) of 1.4 nm by gravure coating, and then dried and cured at 100° C. to form a 1.0 μm-thick undercoat layer comprising a silicone resin. On this undercoat layer, a coating solution obtained by mixing silica sol having a particle diameter of 25 nm and the above-described undercoat solution was coated by gravure coating to form 15 nm-height protrusions on the undercoat layer at a density of 10 protrusions/μm². The undercoat layer was formed on both surfaces of the support film. The obtained stock film was set on a web sputtering apparatus and conveyed while tightly contacting the film with the water-cooled can to form a 30 nm-thick gas barrier layer on the undercoat layer by a DC magnetron sputtering method, a 20 nm-thick underlying layer comprising Ru under the Ar pressure condition of 20 mTorr (2.66 Pa), and a 20 nm-thick magnetic layer comprising (CO₇₀—Pt₂₀—Cr₁₀)₈₈—(SiO₂)₁₂ under an Ar pressure condition of 20 mTorr (2.66 Pa). These gas barrier layer, underlying layer and magnetic layer were formed on both surfaces of the film. Subsequently, the stock film was set on a web-mode protective layer film-forming apparatus shown in FIG. 1, ethylene gas and argon gas were supplied as reactive gases to one unit of ion source 171 or 172 (LIS, trade name, produced by Advanced Energy) disposed to oppose the web under conveyance along a film-forming roll 161 or 162 having a surface property of 0.05 μm in terms of Rz, and a 8 nm-thick DLC protective film comprising C:H=68:32 (by mol) was formed on both surfaces of the film by the ion beam deposition method under a chamber pressure condition of 0.5 mTorr (0.067 Pa). At this time, a voltage of 1,500 V was applied to the anode and the magnetic field applied to the ion source was 0.3 T. Incidentally, at the film formation of the protective layer, the width of the flexible polymer support was 300 nm, the discharge part of the ion source had an elliptic shape, the linear portion thereof was 300 mm, the distance between the ion source and the support was 300 mm, and the support was conveyed at a speed of 1 m/min. Under these conditions, ion beam irradiation at a uniform density could be performed in the width direction of the flexible polymer support.

On the surface of this protective layer, a solution obtained by dissolving a perfluoropolyether-based lubricant having a hydroxyl group at the molecule terminal (FOMBLIN Z-DOL, produced by Audimont Co.) in a fluorine-based lubricant (HFE-7200, produced by Sumitomo 3M Limited) was coated by gravure coating to form a 1 nm-thick lubricating layer. The lubricating layer was also formed on both surfaces of the film. Thereafter, a 3.7-inch disk was punched out from the stock film, subjected to tape burnishing and then integrated into a resin-made cartridge (for Zip100, manufactured by Fuji Photo Film Co., Ltd.), thereby producing a flexible disk.

### Example 2

A flexible disk was produced in the same manner as in Example 1 except that in Example 1, an Ar plasma treatment as a protective layer film-forming pretreatment was performed on the magnetic layer at a charged electric power of 300 W for 20 seconds by using a plasma irradiation apparatus 21 shown in FIG. 2.

### Example 3

A flexible disk was produced in the same manner as in Example 1 except that in Example 1, using two units of ion sources, that is, the ion source 171 and 172 provided to oppose the film-forming roll 161 and the ion source 173 and 174 provided to oppose the film-forming roll 162, a 42 nm-thick protective layer was film-formed by supplying the same reactive gases as in Example 1 to the first unit, and a 2 nm-thick protective layer was film-formed by supplying reactive gases of ethylene gas, argon gas and nitrogen gas to the second unit, thereby forming a two-layer protective layer.

### Example 4

In Example 1, using a 9 μm-thick aramid film having a surface roughness of Ra=1.0 nm as the support, a gas barrier layer, an underlying layer, a magnetic layer and a protective layer were formed on one surface of the support, and a 0.5 μm-thick backcoat layer comprising carbon black was formed on another surface side. In this way a magnetic tape having a width of 8 mm was produced.

### Comparative Example 1

A flexible disk was produced in the same manner as in Example 1 except that in Example 1, the protective film was changed to a DLC film by the RF plasma CVD system using a reaction tube.

### Comparative Example 2

A flexible disk was produced in the same manner as in Example 1 except that in Example 1, the film-forming roll in the protective layer film-forming apparatus was changed to a film-forming roll having Rz of 1.0 μm.

Evaluation:

The magnetic recording mediums obtained above were evaluated as follows.

(1) Evaluation of Film Quality of DLC Protective Layer by Raman Spectroscopy

The film quality of the protective layer was evaluated by the ratios ID/IG and B/A obtained from the Raman spectrum. The Raman spectrum in the range from 1,000 to 2,000 cm⁻¹ at the Ar laser irradiation was measured by a Raman spectrometer produced by the Renishaw Company and after performing waveform separation of D peak and G peak, the peak intensity ratio (ID/IG) was determined. Also, by using, as the background, the inclination of base line excluding the peak portions, the ratio B/A of the G peak intensity B including the background to the G peak intensity A not including the background was determined.

(2) Film Thickness Distribution

The thickness of the DLC film in portions at the center as well as in portions at 150 mm from the center in the width direction of the magnetic recording medium was measured by a stylus-type step-height meter, and the film thickness distribution was evaluated.
Film thickness distribution [%]=(Dₘₐₓ−Dₘᵢₙ)/(Dₘₐₓ+Dₘᵢₙ)×100
(3) Evaluation of Defects

The defects were evaluated by an optical surface defect inspection apparatus. The number of defects is a number of defects per one flexible disk or per tape of 8 mm (width)×1 m (length).

TABLE 1

| | | | Film Thickness | Number of |
|---|---|---|---|---|
| | ID/IG | B/A | Distribution (%) | Defects |
| Example 1 | 0.7 | 1.3 | ±4% | 3 |
| Example 2 | 0.6 | 1.2 | ±4% | 4 |
| Example 3 | 0.8 | 1.4 | ±4% | 8 |
| Example 4 | 0.7 | 1.3 | ±4% | 1 |
| Comparative | 0.8 | 1.5 | ±12% | 31 |
| Example 1 | | | | |
| Comparative | 0.7 | 1.3 | ±4% | 58 |
| Example 2 | | | | |

As seen from the results above, in the flexible disk and the tape of the present invention, the protective layer has good film property and in addition, the film thickness distribution and the number of defects are very small, revealing high productivity. On the other hand, in Comparative Examples 1 and 2, the number of defects is large and the magnetic recording medium fails in having high reliability. Furthermore, in Comparative Example 1, the film thickness distribution is large and the productivity is low.

This application is based on Japanese Patent application JP 2004-164395, filed Jun. 2, 2004, the entire content of which is hereby incorporated by reference, the same as if set forth at length.

1. A method for producing a magnetic recording medium comprising a flexible polymer support, a magnetic layer having a granular structure and a protective layer in this order, the method comprising: forming the magnetic layer on at least one side of the flexible polymer support; and forming the protective layer with use of at least one ion source while conveying the flexible polymer support having the magnetic layer on at least its one side along a roll having a maximum surface roughness is from 0.01 to 0.4 μm.

2. The method according to claim 1, wherein the magnetic layer is plasma-treated before the forming of the protective layer.

3. The method according to claim 1, further comprising forming another protective layer with use of at least one ion source while conveying the flexible polymer support having the magnetic layer on at least its one side along the roll.

4. The method according to claim 2, further comprising forming another protective layer with use of at least one ion source while conveying the flexible polymer support having the magnetic layer on at least its one side along the roll.

5. The method according to claim 1, wherein the roll has a maximum surface roughness of from 0.01 to 0.2 μm.

6. The method according to claim 1, wherein the roll has a maximum surface roughness of from 0.01 to 0.1 μm.

7. The method according to claim 1, wherein the roll has a diameter of 250 mm or more.

8. The method according to claim 1, wherein the roll has a diameter of 400 mm or more.

9. The method according to claim 1, wherein the flexible polymer support is conveyed along the roll at a speed of from 1 μm/min to 10 m/min.

10. The method according to claim 1, wherein the flexible polymer support is conveyed along the roll at a speed of from 10 cm/min to 8 m/min.

11. The method according to claim 1, wherein the magnetic recording medium is a magnetic disk, and the flexible polymer support has a thickness of from 10 to 200 μm.

12. The method according to claim 1, wherein the magnetic recording medium is a magnetic tape, and the flexible polymer support has a thickness of from 1 to 20 μm.

13. The method according to claim 1, wherein the flexible polymer support has a thickness of from 30 to 100 μm.

14. The method according to claim 1, wherein the flexible polymer support contains at least one of aromatic polyimide, aromatic polyamide, aromatic polyamideimide, polyether ketone, polyether sulfone, polyether imide, polysulfone, polyphenylene sulfide, polyethylene naphthalate, polyethylene terephthalate, polycarbonate, triacetate cellulose and fluororesin.

15. The method according to claim 1, wherein the flexible polymer support contains at least one of polyethylene terephthalate and polyethylene naphthalate.

16. The method according to claim 1, wherein the ion source has an electric discharge part having a length larger than a width of the flexible polymer support.
